(19) United States
(12) Patent Application Publication
(10) Pub. No.: US 2001/0032868 A1
(43) Pub. Date: Oct. 25, 2001

(54) CB microphone leash

(76) Inventor: David E. Callahan, Pasadena, TX (US)

Correspondence Address: Martin L. McGregor, McGregor & Associates, 26415 Oak Ridge Drive, Spring, TX, 77380, US

(21) Appl. No.: 09/781,707

(22) Filed: Feb. 12, 2001

Related U.S. Application Data
(60) Provisional application No. 60/196,234, filed on Apr. 10, 2000.

(51) Int. Cl. B60R 11/02; B60R 7/05; B60R 7/06

(52) U.S. Cl. 224/548; 224/312; 224/555; 224/162

(57) ABSTRACT

A communications device leash comprising means adapted for attachment to an interior surface of a vehicle for securing an end of a flexible means having a secureable end and a second end remote from the securable end, the second end being adapted for receiving and retaining a communications device, the flexible means when secured being operable between a first extended position and a second retracted and stored position and means for moving the flexible means from the first extended position to the second retracted and stored position when tension on the flexible means is released. Preferably the leash comprises a spring loaded reel to move the flexible means from the first extended position to the second retracted and stored position. In a preferred embodiment the first extended postion is selectable from a series of positions wherein the flexible member is withdrawn from the secured and stored position in small increments.

### RELATED APPLICATIONS

1. This application is a continuation in part of United States Provisional Patent Application Seriel No. 60/196,234, filed Apr. 10, 2000.

### TECHNICAL FIELD

2. The present invention relates to communication devices and CB radio accessories and more particularly to a leash for the microphone of a CB radio or a cellular telephone handset or entire phone. The leash including a housing having a leash wound on to a spring loaded retraction mechanism and a clip assembly for clipping the housing to the vehicle's visor; an end of the leash having a loop provided therein for positioning over the microphone of a CB radio or the like; the leash recoiling into the retracted position when the device is released by a user to store the device out of the way allowing the user to safely operate the vehicle with an unobstructed view of the road.

### BACKGROUND OF THE INVENTION

Many individuals draped the microphone of the CB radio over the rearview mirror in an easily reached location. Positioning the microphone in this matter obstructs the view of the driver leading to unsafe operating conditions. It would be a benefit, therefore, to have a leash mechanism that could be attached to the microphone of a CB radio which would retract the microphone into a storage location out of the viewing path of the user when the microphone was released by the user. In order to ease installation of the leash mechanism, it would be a further benefit if the leash mechanism included an attachment clip for allowing the user to attach the leash assembly to the visor assembly of the vehicle and a bracket for mounting in other locations.

While retractable leashes, such as those used for walking a pet for example are known, a leash or tether for securing a CB microphone or other communicaitons device in a vehicle has not heretofore been available. Those who use CB radios or other communications devices routinely, such as longhaul truckers or policemen, for example often secure the microphone to the rear view mirror with a bungie cord or other elastic cord. However such cords tangle and slide loose in normal use. Searching for a microphone in a car or truck while driving can creat a dangerous distraction for the driver. There has been a longfelt need, especially among CB microphone users, for a simple means to secure a microphone in a convenient location. The presenr invention fills this long felt need.

### SUMMARY OF THE INVENTION

It is thus an object of the invention to provide a communications device leash. The device includes a housing having a leash wound on to a spring loaded retraction mechanism and a clip assembly for clipping the housing to the vehicle's visor; an end of the leash having a loop provided therein for positioning over the communications device such as the microphone of a CB radio; the leash recoiling into the retracted position when the CB microphone is released by a user to store the device out of the way and allowing the user to safely operate the vehicle with an unobstructed view of the road. Accordingly, a leash is provided. The leash includes a housing having a leash wound on to a spring loaded retraction mechanism and a clip assembly for clipping the housing to the vehicle's visor; an end of the leash having a loop provided for positioning over the microphone of a CB radio; the leash recoiling into the retracted position when the CB microphone is released by a user to store the CB microphone out of the way of our in the user to safely operate the vehicle with an unobstructed view of the road.

Alternatively, the invention may be viewed as a communications device leash comprising means adapted for attachment to an interior surface of a vehicle for securing an end of a flexible means having a secureable end and a second end remote from the securable end, the second end being adapted for receiving and retaining a communications device, the flexible means when secured being operable between a first extended position and a second retracted and stored position and means for moving the flexible means from the first extended position to the second retracted and stored position. In a preferred embodiment the invention provides a CB microphone leash comprising means for mounting a housing to an interior surface of a vehicle operating area, a housing means attached to the mounting means; and extendable means adapted for holding a CB microphone; means for moving the extendable means between and extended position and a stored position within the housing means. Preferably the means for moving the extendable means is a coil spring.

### BRIEF DESCRIPTION OF THE DRAWINGS

For a further understanding of the nature and objects of the present invention, reference should be had to the following detailed description, taken in conjunction with the accompanying drawings, in which like elements are given the same or analogous reference numbers and wherein:

FIG. 1 is a prospective view of an exemplary embodiment of the leash of the present invention.

### DETAILED DESCRIPTION OF THE INVENTION

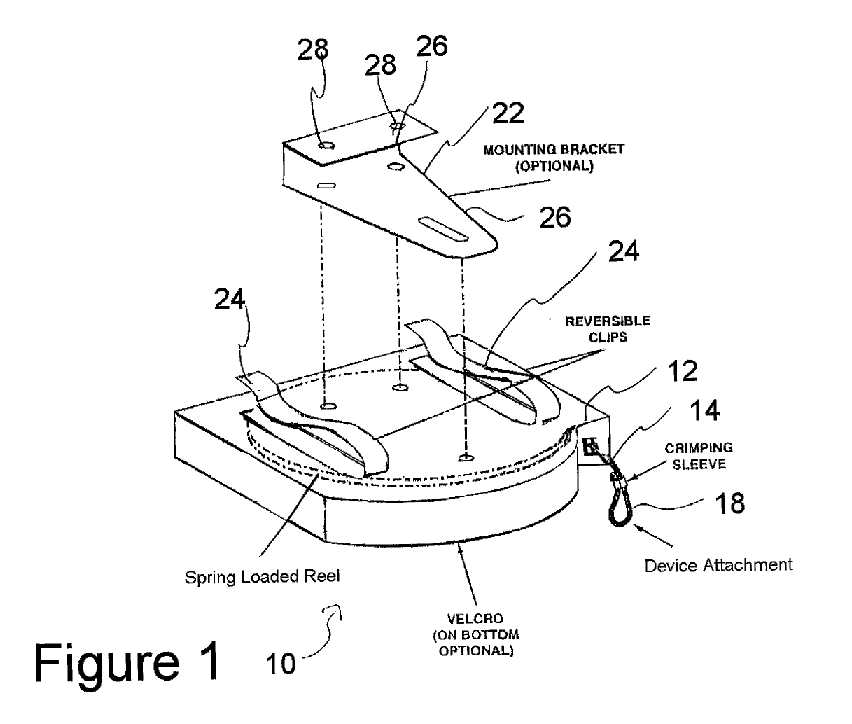

FIG. 1 shows an exemplary embodiment of the leash of the present invention generally designated 10. Leash 10 includes a housing 12 which may be made of plastic, sheet metal or other suitable material. The material of construction will be a matter of design choice and any material may be used so long as it is strong enough to secure and store the leash 14. Leash 14 is a flexiable member wound onto a retraction means 16. Means 16 may be spring loaded, preferably with a coil spring. Leash 14 has a loop 18 for interacting with a CB microphone or other communications device.

In this embodiment CB microphone leash 10 includes both a mounting bracket 22 and a pair of reversible clips 24. Reversible clips 24 can be oriented in either direction and are used to attach microphone leash 10 to a vehicle sun visor. Mounting bracket 22 is secured to housing 12 with screws through screw apertures 26 and securable to a structure on the vehicle using apertures 28. It can be seen from the preceding description that a communications device leash has been provided.

The leash is a flexible member which may be made from any strong flexible material. The leash may also be operated so that the first extended postion is selectable from a series of positions wherein the flexible member is withdrawn from the secured and stored position in small increments, as when a user withdraws the leash by varying amounts depending on the position of the user relative to the position of the secured end of the leash. The preceding describes the best mode of practicing the invention known to the inventors. The preceding description is intended to describe one of many embodiments of the invention and not to limit the invention. One skilled in the art will be aware of many variations of the foregoing which do not depart from the scope and spirit of the invention as defined by the following claims.

I claim:

1. A communications device leash comprising means adapted for attachment to a interior surface of a vehicle for securing an end of a flexible means having a securable end and a second end remote from the securable end, the second end being adapted for receiving and retaining a communications device, the flexible means when secured being operable between a first extended position and a second retracted and stored position and a means for moving the flexible means from the first extended position to the second retracted and stored position.

2. A leash according to claim 1 wherein the means for moving the flexible means from the first position to the second position comprises a spring loaded reel.

3. A CB microphone leash comprising means for mounting a housing to an interior surface a of a vehicle, a housing means attached to the mounting means; and extendable means adapted for holding a CB microphone; and means for moving the extendable means between an extended position and a stored position within the housing means.

4. A CB microphone leash according to claim 3 wherein the means for moving comprises a coil spring.

5. A communications device leash comprising means adapted for attachment to an interior surface of a vehicle for securing an end of a flexible means having a securable end and a second end remote from the securable end, the second end being adapted for receiving and retaining a communications device, the flexible means when secured being operable between a first extended position and a second retracted and stored position and means for moving the flexible means from the first extended position to the second retracted and stored position when tension on the flexible means is released.

6. A leash according to claim 5 comprising a spring loaded reel to move the flexible means from the first extended position to the second retracted and stored position.

7. A leash according to claim 5 wherein the first extended position is selectable from a series of positions wherein the flexible member is withdrawn from the secured and stored position in small increments.
